(19) United States
(12) Patent Application Publication
(10) Pub. No.: US 2025/0180387 A1
(43) Pub. Date: Jun. 5, 2025

(54) METERING DEVICE FOR METERING LIQUID OR PASTY PRODUCTS, IN PARTICULAR FOODS, AND PRODUCTION MACHINE HAVING SUCH A METERING DEVICE

(71) Applicant: Ampack GmbH, Königsbrunn (DE)

(72) Inventors: Detlef Müller, Schwäbisch Hall (DE); Anna Fetsch, Königsbrunn (DE); Jürgen Haak, Plüderhausen (DE); Andreas Rohrer, Langerringen (DE)

(21) Appl. No.: 18/843,909

(22) PCT Filed: Mar. 24, 2023
(86) PCT No.: PCT/EP2023/057671

§ 371 Date: Sep. 4, 2024

(30) Foreign Application Priority Data
Mar. 25, 2022 (DE) 10 2022 107 114.6

(51) Int. Cl. G01F 11/00; B65B 3/12

(52) U.S. Cl. CPC G01F 11/003; B65B 3/12; G01F 11/006; B65B 2210/08

(57) ABSTRACT

A metering device for a metering of liquid or pasty products, in particular food products, includes at least one frame unit (12) and a plurality of pump units (14) for conveying the liquid or pasty products, the pump units (14) being arranged, in particular fixed, on an, in particular plate-shaped, base element (16), in particular on a format plate, of the frame unit (12). The metering device includes at least one stiffening unit (18) having at least one stiffening element (22, 24) which has at least one fluid line (20, 38) and which connects the pump units (14) to one another in an at least substantially rigid manner, the stiffening element (22, 24) being arranged at the pump units (14) on a side of the pump units (14) that faces away from the base element (16) and/or from pump discharge nozzles (60) of the pump units (14).

### CROSS-REFERENCE TO RELATED APPLICATIONS

This patent application is a U.S. national stage application of international patent application PCT/EP2023/057671, filed on Mar. 24, 2023, which is based on and claims priority to German patent application DE 10 2022 107 114.6, filed on Mar. 25, 2022, the contents of which are incorporated herein by reference.

### BACKGROUND

The invention concerns a metering device for a metering of liquid or pasty products, in particular food products, with at least one frame unit and with a plurality of pump units for conveying the liquid or pasty products, the pump units being arranged, in particular fixed, on an, in particular plate-shaped, base element, in particular on a format plate, of the frame unit.

Such metering devices are already known, wherein in the already known metering devices a support of operational forces and torques in the region of the pump units is brought about via the base element, such that a movement of the pump units relative to one another resulting from operational forces and torques can take place. This may result in a high degree of wear on the pump units and to an early breakdown of the pump units.

Furthermore, a metering device for a metering of liquid or pasty products, with at least one frame unit and with a plurality of pump units for conveying the liquid or pasty products, wherein the pump units are arranged on a base element of the frame unit, is already known from DE 22 27 069 A. The metering device already known from DE 22 27 069 A has at least one stiffening unit comprising at least one stiffening element which connects the pump units to one another in an at least substantially rigid manner.

Moreover, a metering device in which a single pump unit is used for conveying liquid or pasty products is already known from GB 2 287 702 A.

### SUMMARY

The objective of the invention is in particular to provide a generic metering device and a generic production machine having improved properties with regard to stability, in particular with regard to flexural rigidity, in the region of a pump block comprising the pump units. The objective is achieved according to the invention.

The invention is based on a metering device for a metering of liquid or pasty products, in particular food products, with at least one frame unit and with a plurality of pump units for conveying the liquid or pasty products, the pump units being arranged, in particular fixed, on an, in particular plate-shaped, base element, in particular on a format plate, of the frame unit.

It is proposed that the metering device has at least one stiffening unit comprising at least one stiffening element which has at least one fluid line and which connects the pump units to one another in an at least substantially rigid manner, the stiffening element being arranged at the pump units on a side of the pump units that faces away from the base element and/or from pump discharge nozzles of the pump units. An implementation according to the invention advantageously allows realizing a high stability, in particular with regard to flexural rigidity, in the region of a pump block of the metering device which comprises the pump units.

Advantageously, a particularly rigid implementation of the pump block comprising the pump units is achievable. An advantageous force flow within the pump block comprising the pump units is achievable in a structurally simple manner. Advantageously, a long service life of the pump block comprising the pump units is achievable, in particular since undesirable movements of the pump units relative to one another can be advantageously counteracted. It is advantageously possible to realize a pump assembly group, in particular of the pump block, which is exchangeable as a whole. Advantageously, retrofitting of the metering device with an alternative pump assembly group is enabled, in particular in order to facilitate simple adaptability of the metering device to desired operational conditions, for example to larger conveying volumes, to different hygiene classes (clean, ultraclean and aseptic) or the like.

Preferably the metering device comprises at least two pump units for conveying the liquid or pasty products. Particularly preferentially the metering device comprises an integer multiple of two pump units for conveying the liquid or pasty products, for example four pump units, six pump units, eight pump units, ten pump units, twelve pump units or the like. However, it is also conceivable for the metering device to comprise an odd number of pump units, for example three pump units, five pump units, seven pump units, nine pump units, eleven pump units or the like. The pump units are preferably connected individually via, in particular individual, feed lines of the metering device to a tank unit of the metering device. The tank unit in particular comprises at least one tank element in which the liquid or pasty product/s can be arranged. It is also conceivable for the tank unit to comprise a plurality of tank elements, wherein in the respective tank elements different products may be arranged, which can be conveyed into containers by means of the pump units, in particular in order to enable so-called sorted filling (ABAB or ABCD). Alternatively or additionally, also for multi-layer products or products with different components a plurality of tank elements and/or a series connection of several metering devices is conceivable, for example in order to enable a pudding topped with cream and filled into a cup, or the like. It is also conceivable that each pump unit is assigned one individual tank element of the tank unit. Further implementations and/or distributions of the tank unit and the pump units, deemed expedient by a person skilled in the art, are likewise conceivable.

The pump units are preferably fixed to the base element, in particular fixed to the base element individually, by means of a form-fit and/or force-fit connection, such as for example by means of a screw connection, a clamping connection, a latching connection, or the like. The pump units are preferably individually demountable from the base element, in particular after removal of the stiffening element from the pump units. The base element is preferably realized in a flexurally rigid fashion. The base element preferably has a maximum thickness of more than 10 mm, preferably of more than 20 mm, and very particularly preferably of more than 25 mm. In particular, the base element has a maximum thickness with a value from a value range of 20 mm to 50 mm. The base element is preferably realized as an, in particular planar, format plate. Preferentially the base element comprises at least one breakthrough for a passage of pump discharge nozzles of the pump units. The base element may have a plurality of individual breakthroughs, wherein each individual breakthrough is assigned one individual pump discharge nozzle, or the base element may have one, in particular central, breakthrough which a plurality of, in particular all, pump discharge nozzles of the pump units are assigned to, in particular through which all pump discharge nozzles of the pump units extend. The base element is preferably arranged on, in particular fixed to, the pump units on a side of the pump units that faces towards the pump discharge nozzles of the pump units. Preferably the breakthrough of the base element or the individual breakthroughs of the base element can be covered by the pump unit(s) by a fixing of the pump units to the base element. Further implementations and/or arrangements of the base element, deemed expedient by a person skilled in the art, are likewise conceivable.

The stiffening element may be embodied as a stiffening bar, as a stiffening plate, as a stiffening tube, as a stiffening bolt, as a stiffening rod or as another component deemed expedient by a person skilled in the art, which connects the pump units to one another in an at least substantially rigid manner. “Connected to one another in a substantially rigid manner” is in particular to mean a connection of at least two elements or units, in particular of the pump units, wherein the elements or units, in particular the pump units, are preferably connected to one another in a manner free of movements relative to one another, with the exception of elastic deformation possibilities, for example elastic deformations due to thermal expansions or the like. Preferably the pump units are connected to one another via the stiffening element in an at least substantially movement-free manner. The pump units are preferably connected to one another via the at least one stiffening element in a manner free of relative movements, with the exception of elastic deformations of, for example, a housing of the pump units or the like and with the exception of functional movements of inner components of the pump units, such as for example functional movements of pistons, of valves, of diaphragms, or the like.

Preferably the stiffening element is arranged at the pump units on a side of the pump units that faces away from the base element and/or from the pump discharge nozzles. However, it is also conceivable that the stiffening element is alternatively or additionally arranged, in particular spatially, between the pump units or on a side of the pump units. It is conceivable, for example, that the stiffening element is embodied as an intermediate plate, which is arranged between at least two pump units and connects the pump units to one another in an at least substantially rigid manner. The stiffening element may comprise an, in particular integrated, fluid line for a discharge of a fluid or for a feeding of a fluid to the pump units. In an implementation of the stiffening element with a fluid line, it is conceivable that the stiffening element is arranged, for example, analogously to an arrangement of an exhaust elbow in an internal combustion engine, on a side of the pump units and connects the pump units to one another in an at least substantially rigid manner. It is also conceivable that the stiffening element extends, in particular at an end of the pump units that faces away from the base element, through the pump units, in particular through housings of the pump units, along a direction that runs transversely, in particular at least substantially perpendicularly, to a drive axis of the pump units, connecting the pump units to one another in an at least substantially rigid manner. If the stiffening element extends through the pump units, it is conceivable that at least one intermediate piece or several intermediate pieces of the stiffening unit is/are arranged at the stiffening element, which is in particular embodied as a threaded rod, as a bar, as a rod, or the like, said intermediate piece/s being configured for a bridging of possible distances between the pump units. For example, the intermediate piece/s may be realized as washers, as an intermediate sheet, as an intermediate plate, or the like. It is also conceivable that the stiffening element is realized in a one-part implementation with the pump units, and in particular forms a portion of two pump housings of the at least two pump units that are connected to one another. “In a one-part implementation” is in particular to mean connected at least by substance-to-substance bond, for example by a welding process, an adhesive-bonding process, an injection-molding process and/or another process deemed expedient by a person skilled in the art, and/or advantageously formed in one piece, such as for example by a production from a cast and/or by a production in a single-component or multi-component injection-molding procedure, and advantageously from a single blank or via an additive manufacturing process, for example 3D printing, or the like.

In particular in at least one exemplary embodiment of the metering device according to the invention, the stiffening element has a maximum thickness, in particular a maximum height, of in particular more than 30 mm, preferably of more than 40 mm, and particularly preferably of more than 50 mm. In particular, the stiffening element has a maximum thickness, in particular a maximum height, with a value from a value range of 40 mm to 80 mm. The stiffening element is preferably connected to the pump units by means of a form-fit and/or force-fit connection and/or by substance-to-substance bond. Preferably the stiffening element is connected to the pump units, in particular fixed to the pump units, in a non-destructive manner, for example by means of a screw connection or the like. The stiffening unit may comprise a single stiffening element via which the pump units are connected to one another in an at least substantially rigid manner, or the stiffening unit may comprise a plurality of stiffening elements via which the pump units are connected to one another in an at least substantially rigid manner. Further implementations and/or arrangements of the stiffening element or the stiffening elements, deemed expedient by a person skilled in the art, are likewise conceivable.

It is further proposed that the pump units are in each case fixed to the base element with one end and are fixed to the stiffening element with a further end. The pump units are preferably arranged spatially between the base element and the stiffening element, in particular when viewed along a direction that runs at least substantially perpendicularly to a main extension plane of the base element. The term “substantially perpendicularly” is in particular meant to define an orientation of a direction relative to a reference direction, wherein the direction and the reference direction, in particular viewed in a projection plane, include an angle of 90° and the angle has a maximal deviation of in particular less than 8°, advantageously less than 5° and particularly advantageously less than 2°. In the arrangement of the pump unit between the base element and the stiffening element, the stiffening element may extend section-wise between the pump units. For example, it is conceivable that the stiffening element is arranged at the pump units on the side of the pump units that faces away from the base element, wherein a projection or a plurality of projections of the stiffening element extend between at least two pump units and wherein the pump units bear directly against the projection or the projections or are fixed thereto. Preferably the stiffening element comprises at least one connection interface, which is realized so as to correspond to a connection interface of at least one pump unit of the plurality of pump units, and comprises at least one further connection interface, which is realized corresponding to a connection interface of at least one further pump unit of the plurality of pump units, wherein the connection interface and the further connection interface of the stiffening element are realized identically. The stiffening element preferably comprises a plurality of connection interfaces realized so as to correspond to connection interfaces of the pump units. A number of the connection interfaces of the stiffening element preferably corresponds to a number of pump units at which the stiffening element can be arranged for an at least substantially rigid connection of the pump units to one another. The implementation according to the invention advantageously allows realizing, by the base element, the pump units and the stiffening element, something like a double-T beam/I beam for a stiffening of the pump block comprising the pump units. Advantageously, high stability, in particular with regard to flexural rigidity, can be realized in the region of the pump block of the metering device which comprises the pump units. Advantageously, an especially rigid implementation of the pump block comprising the pump units is achievable. An advantageous force flow within the pump block comprising the pump units is achievable in a structurally simple manner. Advantageously, a long service life of the pump block comprising the pump units is attainable, in particular since undesirable movements of the pump units relative to one another can be advantageously counteracted.

Furthermore, it is proposed that the stiffening element has a main extension plane which extends at least substantially parallel to a main extension plane of the base element, in particular the aforementioned main extension plane of the base element. By a “main extension plane” of an element or of a unit is in particular a plane to be understood which is parallel to a largest side face of a smallest imaginary cuboid just still completely enclosing the element or the unit, and in particular extends through a center point of the cuboid. Preferentially, in a state when the stiffening element is arranged at the pump units, the main extension plane of the stiffening element extends at least substantially parallel to the main extension plane of the base element on which the pump units are arranged. Preferentially, in a ready-to-operate state, in particular in a state when the metering device has been mounted in a production machine comprising the metering device, the main extension plane of the base element extends at least substantially parallel to a horizontal plane and/or at least substantially parallel to a standing surface of a pedestal or a frame of the production machine. “Substantially parallel” is in particular to mean an orientation of a direction relative to a reference direction, in particular in a plane, wherein the direction has a deviation from the reference direction of in particular less than 8°, advantageously less than 5° and particularly advantageously less than 2°. Preferentially, the stiffening element is arranged on surfaces of the pump units which extend at least substantially parallel to the main extension plane of the base element. The surfaces of the pump units on which the stiffening element is arranged, in particular fixed, at the pump units are preferably arranged on sides of the pump units which, in a state when the pump units are arranged at the base element, face away from the base element. With regard to a mechanical stiffening function, the stiffening element preferably has a function comparable to an upper flange of a double-T beam/I beam. With regard to a mechanical stiffening function, the base element preferably has a function comparable to a lower flange of a double-T beam/I beam. The implementation according to the invention advantageously allows realizing a high stability, in particular with regard to flexural rigidity, in the region of the pump block of the metering device which comprises the pump units. Advantageously, a particularly rigid implementation of the pump block comprising the pump units is obtainable. An advantageous force flow within the pump block comprising the pump units is achievable in a structurally simple manner.

It is also proposed that, viewed along a direction that runs at least substantially parallel to an, in particular the aforementioned, main extension plane of the base element, the stiffening element extends at least over two pump units, in particular over all pump units, of the plurality of pump units and bears against them, in particular directly. The stiffening element extends along the direction that runs at least substantially parallel to the main extension plane of the base element, preferably completely over the two pump units, in particular over all pump units, of the plurality of pump units. Viewed along the direction that runs at least substantially parallel to the main extension plane of the base element, a maximal overall length of the stiffening element preferably corresponds to a maximal extent of the two pump units, in particular of all pump units, of the plurality of pump units along the direction that runs at least substantially parallel to the main extension plane of the base element, in particular plus a distance between the individual pump units. However, it is also conceivable that the maximum overall length of the stiffening element has a different value, deemed expedient by a person skilled in the art, like for example in particular less than 90% and preferentially less than 70% of the maximum extent of the two pump units, in particular of all pump units, of the plurality of pump units along the direction that runs at least substantially parallel to the main extension plane of the base element. Particularly preferentially, viewed along the direction that runs at least substantially parallel to the main extension plane of the base element, the stiffening element extends starting from an edge-side pump unit at least as far as a further edge-side pump unit of the plurality of pump units. For example, if there are in total two pump units, the stiffening element extends from one of the pump units to the other one of the pump units; if there are in total four pump units, the stiffening element extends from an edge-side pump unit as far as a further edge-side pump unit over two pump units situated between the edge-side pump units, etc. Preferably the pump units are, in particular in alignment with one another, arranged at the base element in a row, wherein the stiffening element extends over the row. However, it is also conceivable that the pump units have a different arrangement at the base element that is deemed expedient by a person skilled in the art, like for example a zigzag-like arrangement, an arcuate arrangement, a circular arrangement, a polygonal arrangement, or the like. In a state when arranged at the base element, the pump units, in particular directly neighboring pump units, preferably have a distance from one another along the direction that runs at least substantially parallel to the main extension plane of the base element. The distance of the pump units, in particular of the directly neighboring pump units, has a maximum value that is in particular less than 40 mm, preferably less than 30 mm, and very particularly preferably less than 20 mm. Particularly preferentially, the distance between the directly neighboring pump units has a maximal value from a value range of 15 mm to 18 mm. Preferentially the distance between all directly neighboring pump units is identical with respect to its value, in particular except for tolerance differences. The implementation according to the invention advantageously allows achieving a structurally simple connection of the pump units in order to realize an at least substantially rigid connection. Advantageously, high stability, in particular with regard to flexural rigidity, can be realized in the region of the pump block of the metering device which comprises the pump units. Advantageously, a particularly rigid implementation of the pump block comprising the pump units is achievable. An advantageous force flow within the pump block comprising the pump units is achievable in a structurally simple manner. Advantageously, a long service life of the pump block comprising the pump units is achievable, in particular since undesirable movements of the pump units relative to one another can be advantageously counteracted.

Beyond this, it is proposed that the stiffening unit comprises at least one further stiffening element, which in particular comprises at least one fluid line, and which connects the pump units to one another in an at least substantially rigid manner. The further stiffening element preferably has an at least substantially analogous implementation to the stiffening element, in particular an identical implementation. In particular, a description of the stiffening element analogously also applies to the further stiffening element. However, it is also conceivable that the further stiffening element has a different implementation in comparison to the stiffening element, in particular with respect to additional functions of the further stiffening element, such as for example conducting of a fluid, a heat transport, or the like. Preferably the stiffening element and/or the further stiffening element are made of a metallic material. However, it is also conceivable that the stiffening element and/or the further stiffening element are/is made of a different material that is deemed expedient by a person skilled in the art, such as for example from a synthetic material, from a composite material, or the like. The stiffening element and the further stiffening element may be connected to one another, in particular in addition to a connection via the pump units, for example by means of a form-fit and/or force-fit connection. Preferably, the stiffening element and the further stiffening element are components realized separately from one another, which can be arranged, in particular are arranged, on the pump units individually. The implementation according to the invention advantageously allows selecting large tolerance ranges for a production of the stiffening unit, and nevertheless advantageously high stability is made possible. Advantageously, a structurally simple connection of the pump units can be achieved in order to realize an at least substantially rigid connection. Advantageously, a particularly rigid implementation of the pump block comprising the pump units is achievable.

It is further proposed that together with the stiffening element and with the base element the pump units are realized such that they are module-wise exchangeable as a whole. Preferably, the pump units together with the stiffening element and with the base element, in a state in which they are fixed to one another, form an assembly-group module, which is preferably detachable from other components and units as a whole and is exchangeable, for example in the event of a defect of the pump units, in the event of a change of a maximal conveying volume, or in the event of a change of another requirement on the pump units. Preferably the pump units together with the stiffening element and with the base element form a mounting module. A “mounting module” is in particular to mean a module comprising a plurality of components which are configured to be pre-assembled to form a unit which is then mounted in a further unit as a whole. The implementation according to the invention advantageously allows achieving a modularity at least in the region of the pump block comprising the pump units. With the stiffening element a high level of stability is also achievable during removal of the pump block from the remaining portion of the metering device, in particular in order to counteract undesirable deformations of the pump block when it is demounted from the metering device. Advantageously, depending on a customer's wishes, the desired flexurally rigid pump block is easily and quickly exchangeable. It is advantageously possible to achieve a high level of stability, in particular with regard to flexural rigidity, in the region of the pump block of the metering device which comprises the pump units. Advantageously, a particularly rigid implementation of the pump block comprising the pump units is achievable. Advantageously, a pump assembly group, in particular of the pump block, can be realized which is exchangeable as a whole. Advantageously, retrofitting of the metering device with an alternative pump assembly group is facilitated, in particular in order to enable easy adaptability of the metering device to desired operational conditions, for example to larger conveying volumes, to different hygiene classes (clean, ultraclean and aseptic), or the like.

Beyond this, it is proposed that the stiffening element comprises at least one fluid line, which is configured for conveying, in particular discharging, a CIP cleaning medium that is provided for a CIP (clean-in-place) cleaning of the pump units. Preferentially the fluid line is integrated in the stiffening element. The fluid line is preferably realized as an inner channel in the stiffening element. The fluid line is preferably fluidically connected to a flushing opening of the pump units, in particular in a state when the stiffening element is arranged at the pump units. The stiffening element preferably forms a CIP bar (clean-in-place bar). The further stiffening element preferably comprises an integrated fluid line. The fluid line of the further stiffening element is realized analogously to the fluid line of the stiffening element. The further stiffening element preferably forms a further CIP bar (clean-in-place bar). The implementation according to the invention allows integrating an additional function in the stiffening element and/or in the further stiffening element in a structurally simple manner. Advantageously, high stability, in particular with regard to flexural rigidity, can be realized in the region of the pump block of the metering device which comprises the pump units, with an additional functional implementation of the pump block comprising the pump units.

It is moreover proposed that the metering device comprises at least one drive unit which is arranged on a base frame of the frame unit, wherein the base frame is fixed to the base element and the pump unit is arranged at least at one end, in particular the further end with which the stiffening element is arranged at the pump units, between two side wall elements of the base frame without a rigid connection. Preferably the pump units are at their further ends free of a direct connection to the side wall elements. The stiffening element and/or the further stiffening element are/is preferably arranged, without a rigid connection, between the two side wall elements of the base frame, in particular when viewed along the direction that runs at least substantially parallel to the main extension plane of the base element. The stiffening element and/or the further stiffening element are/is preferably free of a direct connection to the side wall elements. It is conceivable that in order to solve the aforementioned task, the metering device is realized in an alternative implementation independently of the stiffening unit. Preferably, in the alternative implementation, in particular in the implementation realized independently of the stiffening unit, for a metering of liquid or pasty products, in particular food products, the metering device comprises at least one frame unit, a plurality of pump units for conveying the liquid or pasty products, the pump units being arranged, in particular fixed, on an, in particular plate-shaped, base element, in particular a format plate, of the frame unit, the metering device further comprising at least one drive unit which is arranged on a base frame of the frame unit, wherein the base frame is fixed to the base element and the pump unit is arranged at least at one end, in particular the further end with which the stiffening element is arranged at the pump units, between two side wall elements of the base frame without a rigid connection. The term “without a rigid connection” is in particular meant to define an arrangement of components or units relative to one another wherein the components or units are spaced apart from one another at least region-wise and wherein, in particular in at least one region, there is a gap between the components or units. In particular viewed along the direction that runs at least substantially parallel to the main extension plane of the base element, the pump units are preferably arranged spaced apart from one another relative to the side wall elements, at least with their further end, which faces away from the end of the pump units with which the pump units are fixed to the base element. Preferentially, in particular for a compensation of elastic deformations, for example heat-induced elastic deformations or the like, the pump units are capable of moving relative to the side wall elements at least in the region of the further end, in particular when viewed along the direction that runs at least substantially parallel to the main extension plane of the base element. The stiffening element and/or the further stiffening element are/is preferably arranged spaced apart from the side wall elements, in particular when viewed along the direction that runs at least substantially parallel to the main extension plane of the base element. Preferentially, in particular for a compensation of elastic deformations, for example heat-induced elastic deformations or the like, the stiffening element and/or the further stiffening element are/is capable of moving relative to the side wall elements at least in the region of the further end, in particular when viewed along the direction that runs at least substantially parallel to the main extension plane of the base element. The drive unit preferably comprises a plurality of drives for driving the pump units. The drives may be realized as electric drives, as hydraulic drives, as pneumatic drives, as mechanical drives, for example cam disk drives or the like, or as other drives deemed expedient by a person skilled in the art. It is conceivable that the drive unit has one single drive per pump unit or that the drive unit drives several pump units with one drive, wherein in terms of driving technology the pump units are connected to the drive via a coupling and/or via a transmission. The implementation according to the invention advantageously allows achieving a rigid implementation of the pump block comprising the pump units, wherein advantageously an elastic deformation of the pump block comprising the pump units is achievable in the region of the drive block, in particular in order to realize long service lives. A particularly long-life metering device can be realized. Advantageously, a high level of stability, in particular with regard to flexural rigidity, can be realized in the region of a drive block of the metering device which comprises the drive unit. Advantageously, a particularly rigid implementation of the pump block comprising the pump units and of the drive block comprising the drive unit is achievable.

Furthermore, it is proposed that the stiffening unit comprises at least one flexurally rigid, in particular double-T-beam-shaped, drive stiffening element on which the drive unit, in particular a plurality of drives of the drive unit, is arranged, in particular fixed, wherein the drive stiffening element, which in particular has at least one longitudinal axis that extends substantially parallel to a main extension plane of the stiffening element, is connected to the side wall elements in an at least substantially rigid manner. The drive unit is preferably fixed to the drive stiffening element by means of a form-fit and/or force-fit connection, for example by a screw connection, a clamping connection, a latching connection, or the like. The drive stiffening element is preferably, in an at least substantially rigid manner, connected to the side wall elements at an end of the side wall elements that faces away from the base element. The drive stiffening element is preferentially connected to the side wall elements by means of a form-fit and/or force-fit connection and/or by substance-to-substance bond. Preferably the drive stiffening element is connected to the side wall elements, in particular fixed to the side wall elements, in a non-destructive manner, for example by a screw connection or the like. It is also conceivable that the drive stiffening element is realized in a one-part implementation with the side wall elements. The side wall elements preferably extend transversely, in particular at least substantially perpendicularly, to the longitudinal axis of the drive stiffening element and/or to the main extension plane of the base element. The implementation according to the invention advantageously allows achieving a rigid implementation of the drive block comprising the drive unit. An especially long-life metering device can be realized. Advantageously, a high level of stability, in particular with regard to flexural rigidity, can be realized in the region of the drive block of the metering device which comprises the drive unit. Advantageously, a particularly rigid implementation of the pump block comprising the pump units and of the drive block comprising the drive unit is achievable.

Furthermore, a production machine with at least one metering device according to the invention is proposed. The production machine may comprise further devices and/or units which are deemed expedient by a person skilled in the art and which can be used for a handling of products, in particular food products. The production machine is preferably configured for production, filling, packaging and/or secondary packaging of food products. In addition to the metering device, the production machine may comprise a plurality of further devices and/or units deemed expedient by a person skilled in the art, like for example a forming device for packagings, a cutting device, a filling device, a sterilization device, a closure device, a secondary-packaging device, a container feed device, or the like. The implementation according to the invention advantageously allows realizing a production machine with a stable metering device. It is preferably possible to achieve comfortable exchangeability of individual units or components, in particular of the pump block and/or of the drive block, for a functional modification of the metering device.

The metering device according to the invention and/or the production machine according to the invention shall here not be limited to the application and implementation described above. In particular, in order to fulfil a functionality that is described here, the metering device according to the invention and/or the production machine according to the invention may comprise a number of individual elements, components and units that differs from a number mentioned. Moreover, as for the value ranges indicated in this disclosure, values situated within the mentioned limits shall also be considered to be disclosed and usable as desired.

### BRIEF DESCRIPTION OF THE DRAWINGS

Further advantages will become apparent from the following description of the drawings. In the drawings an exemplary embodiment of the invention is illustrated. The drawings, the description and the claims contain a plurality of features in combination. A person skilled in the art will purposefully also consider the features individually and will find further expedient combinations.

In the drawings:

FIG. 1 shows a production machine according to the invention with at least one metering device according to the invention, in a schematic illustration,

FIG. 2 shows a detailed view of the metering device according to the invention, in a schematic illustration,

FIG. 3 shows a pump block of the metering device according to the invention, comprising pump units of the metering device according to the invention, in a schematic illustration,

FIG. 4 shows a drive block of the metering device according to the invention, comprising a drive unit of the metering device according to the invention, in a schematic illustration,

FIG. 5 shows a sterile-fluid distributor unit of the metering device according to the invention, which is arranged on the pump units, in a schematic illustration, and

FIG. 6 shows a lifting unit of the metering device according to the invention, which is arrangeable on a frame unit of the metering device according to the invention, in a schematic illustration.

### DETAILED DESCRIPTION

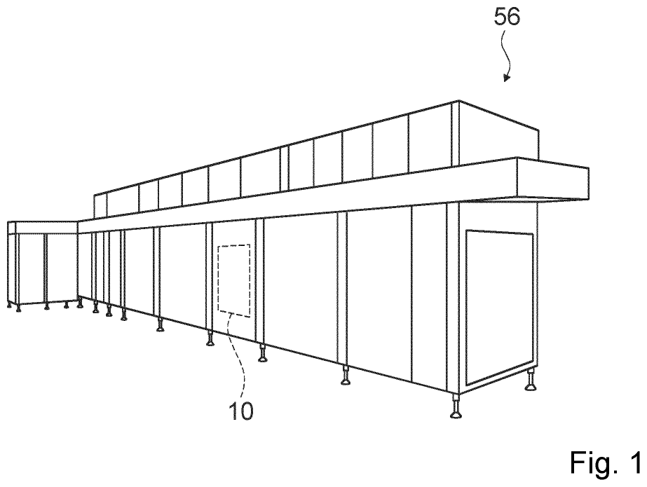

FIG. 1 shows a production machine 56 with at least one metering device 10 for a metering of liquid or pasty products, in particular food products. The production machine 56 is preferably configured for a production and/or for a processing of products, in particular food products. The production machine 56 may be realized, for example, as a food product packaging machine, as a food product filling machine, as a food production machine, as a combination of the aforementioned machines, or the like. The production machine 56 may comprise devices and/or units which are deemed expedient by a person skilled in the art and which are used for a production and/or processing of products, in particular food products, like for example a sterilization device, a filling device, a closure device, a secondary-packaging device, a container feed device, or the like.

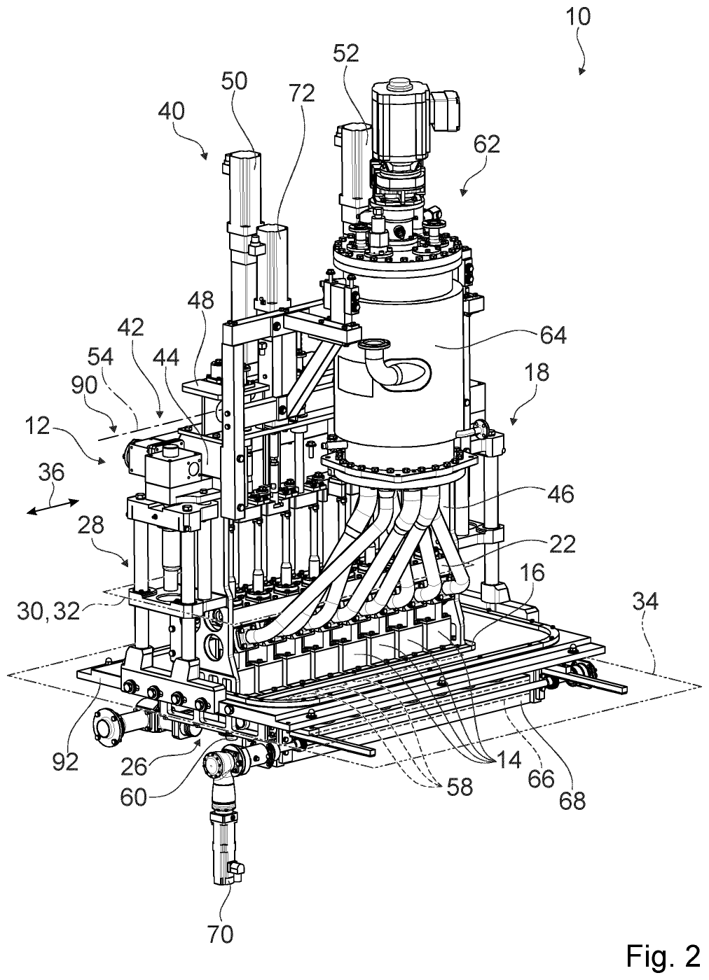

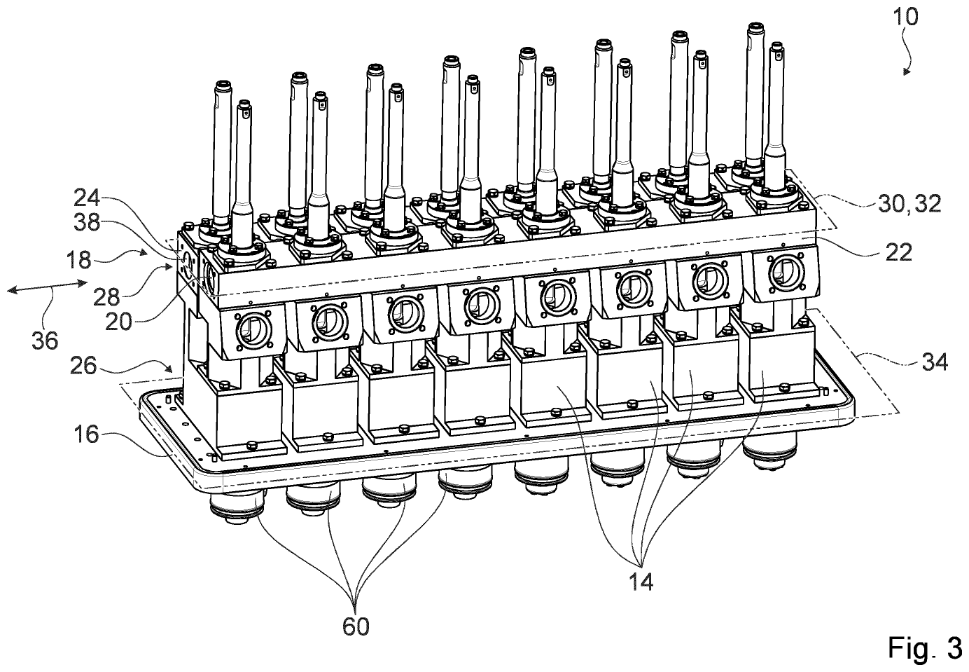

FIG. 2 shows a detailed view of the metering device 10 for a metering of liquid or pasty products, in particular food products, into containers (not shown here in detail), in particular into cup-shaped containers. The metering device 10 comprises at least one frame unit 12 and a plurality of pump units 14 for conveying the liquid or pasty products, wherein the pump units 14 are arranged, in particular fixed, on an, in particular plate-shaped, base element 16, in particular a format plate, of the frame unit 12 (cf. also FIG. 3). In the exemplary embodiment described here, the metering device 10 comprises by way of example eight pump units 14. However, it is also conceivable that the metering device 10 comprises another number of pump units 14 that is deemed expedient by a person skilled in the art, in particular a number that is appropriate for a specific field of use of the metering device 10. Preferably the pump units 14 are, in particular in alignment with one another, arranged at the base element 16 in a row (cf. FIG. 3). The pump units 14 are preferably fixed to the base element 16, in particular fixed to the base element 16 individually, by means of a form-fit and/or force-fit connection, for example by a screw connection, a clamping connection, a latching connection, or the like. Preferably the pump units 14 are individually demountable from the base element 16. Preferentially the base element 16 comprises at least one breakthrough 58 for a passage of pump discharge nozzles 60 of the pump units 14 (cf. FIG. 3). The pump discharge nozzles 60 of the pump units 14 are preferably fixed to the pump units 14 in such a way that they are individually exchangeable. In the exemplary embodiment illustrated here, the base element 16 has a plurality of individual breakthroughs 58, wherein each individual breakthrough 58 is assigned one single pump discharge nozzle 60 of an individual pump unit 14. However, it is also conceivable that the base element 16 has one, in particular central, breakthrough 58 to which several, in particular all, pump discharge nozzles 60 of the pump units 14 are assigned, and through which in particular all pump discharge nozzles 60 of the pump units 14 extend. The pump discharge nozzles 60 of the pump units 14 may all have an identical implementation or may be realized differently. Preferably the pump discharge nozzles 60 are realized in such a way that they are individually exchangeable. The pump discharge nozzles 60 may be realized as a flat valve nozzle, as a screw slide nozzle, as a rotary slide nozzle, or as another pump discharge nozzle 60 deemed expedient by a person skilled in the art. The base element 16 is preferably arranged on, in particular fixed to, the pump units 14 on a side of the pump units 14 that faces towards the pump discharge nozzles 60 of the pump units 14. Preferably the individual breakthroughs 58 of the base element 16 are covered by the pump units 14 due to a fixing of the pump units 14 at the base element 16.

The metering device 10 preferably comprises at least one tank unit 62 comprising at least one tank element 64 in which the liquid or pasty product/s can be arranged. A mixer unit is preferably arranged at the tank unit 62 in a manner already known to a person skilled in the art. The pump units 14 are preferably connected to the tank element 64 individually via, in particular individual, feed lines of the metering device 10. It is also conceivable for the tank unit 62 to comprise a plurality of tank elements 64, wherein in the respective tank elements 64 different products are arrangeable which can be conveyed into containers by means of the pump units 14, thus making multi-layer products or products with different components possible, for example a pudding topped with cream and filled into a cup, or the like. In an implementation of the tank unit 62 with a plurality of tank elements 64, preferably each pump unit 14 is assigned one single tank element 64 of the tank unit 62. Furthermore, it is also conceivable that the pump unit 14 can be supplied with products individually or jointly via a pipeline system of the production machine 56, and that the products are stored in remote silos, or the like. Further implementations and/or distributions of the tank unit 62 and the pump units 14, deemed expedient by a person skilled in the art, are likewise conceivable.

The metering device 10 includes at least one stiffening unit 18 comprising at least one stiffening element 22, which in particular comprises at least one fluid line 20 and which connects the pump units 14 to one another in an at least substantially rigid manner (cf. FIGS. 2 and 3). Preferably the stiffening unit 18 includes at least one further stiffening element 24, which in particular comprises at least one fluid line 38 and which connects the pump units 14 to one another in an at least substantially rigid manner. The further stiffening element 24 preferably has an at least substantially analogous implementation to the stiffening element 22, in particular an identical implementation. In particular, a description of the stiffening element 22 analogously also applies to the further stiffening element 24. However, it is also conceivable that the further stiffening element 24 has a different implementation in comparison to the stiffening element 22, in particular with respect to additional functions of the further stiffening element 24, such as for example conducting of a fluid, heat transport, or the like.

Preferentially the pump units 14 are in each case fixed to the base element 16 with one end 26 and to the stiffening element 22 and/or to the further stiffening element 24 with a further end 28. The pump units 14 are preferably arranged spatially between the base element 16 and the stiffening element 22 and/or the further stiffening element 24, in particular when viewed along a direction that runs at least substantially perpendicularly to a main extension plane 34 of the base element 16. The stiffening element 22 preferably has a main extension plane 30 which extends at least substantially parallel to the main extension plane 34 of the base element 16. The further stiffening element 24 preferably has a main extension plane 32 which extends at least substantially parallel to the main extension plane 34 of the base element 16. Preferably, viewed along a direction 36 that runs at least substantially parallel to the main extension plane 34 of the base element 16, the stiffening element 22 extends at least over two pump units 14, in particular over all pump units 14, of the plurality of pump units 14 and bears against them, in particular directly. Preferentially, viewed along the direction 36 that runs at least substantially parallel to the main extension plane 34 of the base element 16, the further stiffening element 24 extends at least over two pump units 14, in particular over all pump units 14, of the plurality of pump units 14 and bears against them, in particular directly. The stiffening element 22 and the further stiffening element 24 are preferably arranged side by side, in particular fixed, at the pump units 14, wherein the stiffening element 22 and the further stiffening element 24 extend over the pump units 14 along the direction 36. Together with the stiffening element 22, with the further stiffening element 24 and with the base element 16, the pump units 14 are preferably realized such that they are module-wise exchangeable as a whole, and are in particular realized so as to be removable from the frame unit 12 as a whole.

The stiffening element 22 and/or the further stiffening element 24 may be realized as a stiffening bar, as a stiffening plate, as a stiffening tube, as a stiffening bolt, as a stiffening rod or as another component, deemed expedient by a person skilled in the art, which connects the pump units 14 to one another in an at least substantially rigid manner. In the exemplary embodiment illustrated here, the stiffening element 22 and the further stiffening element 24 are preferably realized as CIP bars. Preferably, the stiffening element 22 and the further stiffening element 24 respectively comprise an, in particular integrated, fluid line 20, 38 for a discharge or a feeding of a fluid to the pump units 14. The stiffening element 22 and/or the further stiffening element 24 comprise/comprises at least the fluid line 20, 38, which is configured for a conveying, in particular a discharging, of a CIP cleaning medium provided for a CIP cleaning of the pump units 14. The metering device 10 preferably comprises at least one cleaning feed line 66 via which the CIP cleaning medium can be fed to the pump units 14 (cf. FIG. 2). The cleaning feed line 66 is preferably arranged, in particular integrated, in a coupling element 68 that is supported movably relative to the base element 16 (cf. FIG. 2). The coupling element 68 is preferably realized as a flushing bar, which is actively movable relative to the base element 16 by means of a motor 70 of the metering device 10. The coupling element 68 preferably comprises a plurality of coupling openings (not shown here in detail). A number of coupling openings preferably depends on the number of pump units 14, in particular on the number of pump discharge nozzles 60. The coupling openings are preferably configured to receive the pump discharge nozzles 60 in a cleaning position of the coupling element 68. In the cleaning position of the coupling element 68, the cleaning medium is preferably introduced into the pump units 14 via the pump discharge nozzles 60 and is discharged via the fluid line 20 of the stiffening element 22 and/or via the fluid line 38 of the further stiffening element 24.

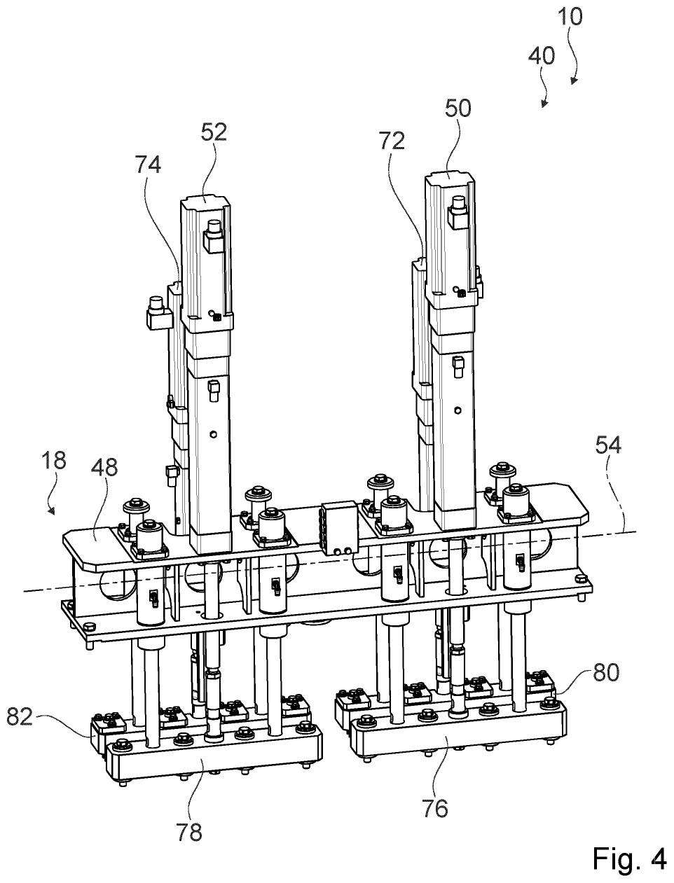

The metering device 10 furthermore comprises at least one drive unit 40 (cf. FIGS. 2 and 4) which is arranged on a base frame 42 of the frame unit 12, wherein the base frame 42 is fixed to the base element 16 and the pump unit 14 is arranged, without a rigid connection, between two side wall elements 44, 46 of the base frame 42 at least with one end 28, in particular the further end 28, on which the stiffening element 22 and/or the further stiffening element 24 are/is arranged at the pump units 14 (cf. FIG. 2). The pump units 14 are preferably free of a direct connection to the side wall elements 44, 46 at the further ends 28. The stiffening element 22 and/or the further stiffening element 24 are/is preferably arranged, without a rigid connection, between the two side wall elements 44, 46 of the base frame 42, in particular when viewed along the direction 36 that runs at least substantially parallel to the main extension plane 34 of the base element 16. Preferably the stiffening element 22 and/or the further stiffening element 24 are/is free of a direct connection to the side wall elements 44, 46. The pump units 14 as well as the stiffening element 22 and/or the further stiffening element 24 are preferably arranged spatially between the base element 16 and the drive unit 40, in particular when viewed along the direction that runs at least substantially perpendicularly to the main extension plane 34 of the base element 16.

FIG. 4 shows the drive unit 40 in a state when removed from the frame unit 12. The drive unit 40 preferably comprises a plurality of drives 50, 52, 72, 74 for driving the pump units 14. The drives 50, 52, 72, 74 may be realized as electric drives, as hydraulic drives, as pneumatic drives, or as other drives deemed expedient by a person skilled in the art. In the exemplary embodiment illustrated in the figures, the drive unit 40 comprises four drives 50, 52, 72, 74, wherein two drives 50, 52 are configured for a piston drive of the pump units 14 and two drives 72, 74 are configured for a valve drive of the pump units 14. However, it is also conceivable that the drive unit 40 comprises respectively one single drive per piston of the pump units 14 and per valve of the pump units 14. The drive unit 40 preferably comprises one coupling element 76, 78, 80, 82 per drive 50, 52, 72, 74, wherein the respective coupling element 76, 78, 80, 82 connects four drive elements, in particular drive shafts, of the pump units 14 to one another. Preferentially four piston drive shafts of the pump units 14 per drive 50, 52 and four valve drive shafts of the pump units 14 per drive 72, 74 are connected to one another in terms of driving technology via respectively one of the coupling elements 76, 78, 80, 82 (cf. FIGS. 2 and 4). However, it is also conceivable that per piston drive shaft and per valve drive shaft a single drive of the drive unit 40 is provided in order to realize a single drive of the respective piston drive shaft and the respective valve drive shaft.

The stiffening unit 18 preferably comprises at least one flexurally rigid, in particular double-T-beam-shaped, drive stiffening element 48 on which the drive unit 40, in particular the drives 50, 52, 72, 74 of the drive unit 40, is/are arranged, in particular fixed, wherein the drive stiffening element 48, which in particular has at least one longitudinal axis 54 extending substantially parallel to the main extension plane 30, 32 of the stiffening element 22 and/or of the further stiffening element 24, is connected to the side wall elements 44, 46 in an at least substantially rigid manner. The drive stiffening element 48 is preferably arranged on, in particular fixed to, the side wall elements 44, 46 on a side of the side wall elements 44, 46 that faces away from the base element 16. The drive stiffening element 48 is preferably arranged—as a whole together with the drive unit 40—on, in particular fixed to, the side wall elements 44, 46 in a module-wise exchangeable fashion. For driving the piston drive shafts, the drives 50, 52 are preferably arranged on, in particular fixed to, an upper flange of the drive stiffening element 48. For driving the valve drive shafts, the drives 72, 74 are preferentially arranged on, in particular fixed to, a lower flange of the drive stiffening element 48. However, it is also conceivable that all drives 50, 52, 72, 74 are arranged on, in particular fixed to, the upper flange or the lower flange of the drive stiffening element 48, or that the drives 50, 52 for driving the piston drive shafts are arranged on, in particular fixed to, the lower flange, while the drives 72, 74 for driving the valve drive shafts are arranged on, in particular fixed to, the upper flange. In a state when the stiffening element 22 is arranged at the pump units 14, the valve drive shafts preferably extend through the stiffening element 22, in particular when viewed along the direction that runs at least substantially perpendicularly to the main extension plane 34 of the base element 16. In a state when the further stiffening element 24 is arranged at the pump units 14, the piston drive shafts preferably extend through the further stiffening element 24, in particular when viewed along the direction that runs at least substantially perpendicularly to the main extension plane 34 of the base element 16. Further implementations and/or arrangements of the drive unit 40 on the drive stiffening element 48, deemed expedient by a person skilled in the art, are likewise conceivable.

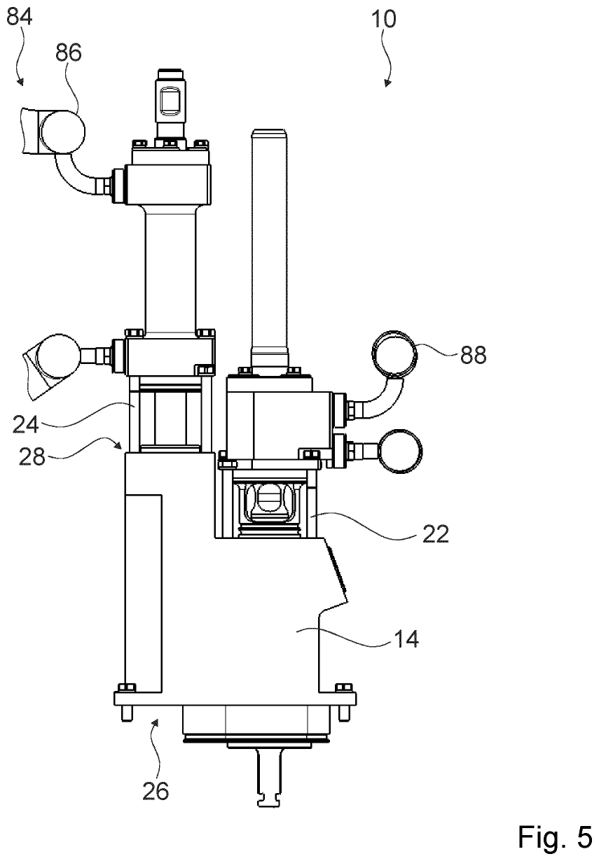

FIG. 5 shows a sterile-fluid distributor unit 84 which is, in particular optionally, arrangeable on the pump units 14. The sterile-fluid distributor unit 84 may preferably be provided optionally on, in particular retrofitted to, the pump units 14, in particular depending on a field of use of the metering device 10. The sterile-fluid distributor unit 84 is preferably arrangeable at the pump units 14 spatially between the drive stiffening element 48 and the stiffening element 22 and/or the further stiffening element 24, in particular when viewed along the direction that runs at least substantially perpendicularly to the main extension plane 34 of the base element 16. The sterile-fluid distributor unit 84 is preferably configured for conveying, in particular feeding, sterile air to the pump units 14. Preferentially the sterile-fluid distributor unit 84 comprises a sterile-air distributing line 86 that is assigned to the piston drive shafts. The piston drive shafts preferably extend through the sterile-air distributing line 86 that is assigned to the piston drive shafts. Preferably, sealing elements are arranged in the region of the piston drive shafts in a manner already known to a person skilled in the art. Preferentially the sterile-fluid distributor unit 84 comprises a sterile-air distributing line 88 that is assigned to the valve drive shafts. The valve drive shafts preferably extend through the sterile-air distributing line 88 that is assigned to the valve drive shafts. Preferably, sealing elements are arranged in the region of the valve drive shafts in a manner already known to a person skilled in the art.

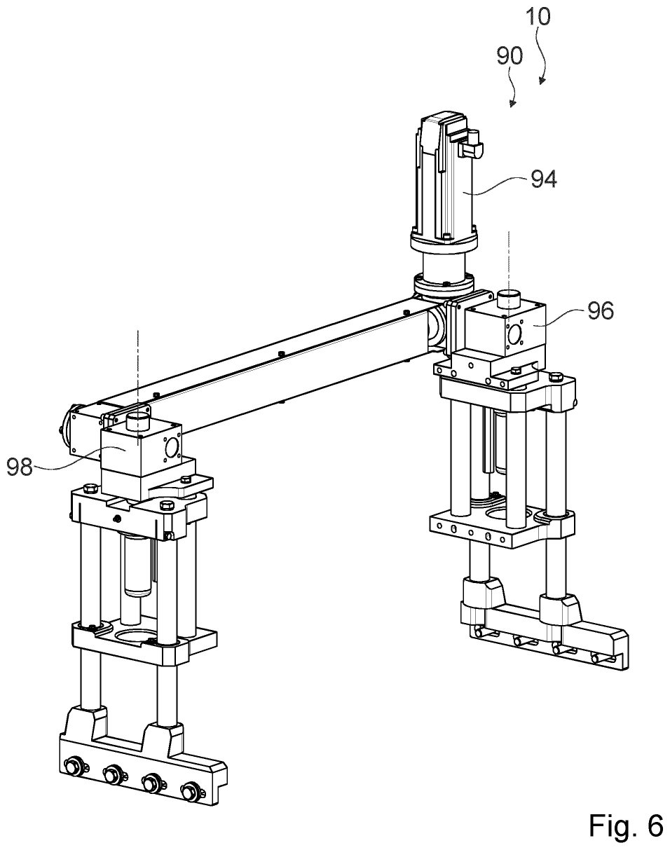

FIG. 6 shows a lifting unit 90 which is, in particular optionally, arrangeable on the frame unit 12. The lifting unit 90 may preferably be provided optionally, and may in particular be retrofitted, in particular depending on a field of use of the metering device 10. The lifting unit 90 is preferably arrangeable on, in particular fixed to, the side wall elements 44, 46 (cf. FIG. 2). The lifting unit 90 is preferably, with an end that faces away from the pump units 14, arrangeable on, in particular fixed to, a base frame element 92 of the frame unit 12. In particular viewed in the main extension plane 34 of the base element 16, the base frame element 92 surrounds the base element 16, in particular completely. A relative position of the base element 16 with respect to the base frame element 92, in particular along the direction that runs at least substantially perpendicularly to the main extension plane 34 of the base element 16, can be changed actively by means of the lifting unit 90. The lifting unit 90 preferably comprises a lifting motor 94 configured to drive two linear cylinders 96, 98, in particular via a synchroniser shaft of the lifting unit 90, in particular in order to actively change a relative position of the base element 16. It is in particular conceivable that, if the metering device 10 is equipped with different drive units 40 and/or pump units 14, a relative position of the base element 16 can be changed in order to arrange the drive units 40 and/or pump units 14 on the frame unit 12 in a suitable manner. The metering device 10 is preferably arranged on, in particular fixed to, a machine frame of the production machine 56 by means of the base frame element 92. Alternatively to the lifting unit 90, the metering device 10 may also comprise a non-adjustable carrier unit (not shown here in detail) connecting the side wall elements 44, 46 to the base frame element 92, in particular fixing the side wall elements 44, 46 to the base frame element 92 in a non-adjustable manner. Further implementations of the metering device 10 deemed expedient by a person skilled in the art, with additional or alternative units and/or elements which are expedient for a field of use of the metering device 10, are likewise conceivable.

1. A metering device for a metering of liquid or pasty products, comprising at least one frame unit (12) and a plurality of pump units (14) for conveying the liquid or pasty products, the pump units (14) being arranged on a base element (16) of the frame unit (12), further comprising at least one stiffening unit (18) comprising at least one stiffening element (22, 24) which has at least one fluid line (20, 38) and which connects the pump units (14) to one another in an at least substantially rigid manner, the stiffening element (22, 24) being arranged at the pump units (14) on a side of the pump units (14) that faces away from the base element (16) and/or from pump discharge nozzles (60) of the pump units (14).

2. The metering device according to claim 1, wherein the pump units (14) are in each case fixed to the base element (16) with one end (26) and are fixed to the at least one stiffening element (22, 24) with a further end (28).

3. The metering device according to claim 1, wherein the at least one stiffening element (22, 24) has a main extension plane (30, 32) which extends at least substantially parallel to a main extension plane (34) of the base element (16).

4. The metering device according to claim 1, wherein viewed along a direction (36) that runs at least substantially parallel to a main extension plane (34) of the base element (16), the at least one stiffening element (22, 24) extends at least over two pump units (14) of the plurality of pump units (14) and bears against them.

5. The metering device according to claim 1, wherein the at least one stiffening unit (18) comprises at least one further stiffening element (22, 24), which connects the pump units (14) to one another in an at least substantially rigid manner.

6. The metering device according to claim 1, wherein together with the at least one stiffening element (22, 24) and with the base element (16), the plurality of pump units (14) are configured such that they are module-wise exchangeable as a whole.

7. The metering device according to claim 1, wherein the at least one stiffening element (22, 24) comprises at least one fluid line (20, 38) which is configured for conveying a CIP cleaning medium provided for a CIP cleaning of the pump units (14).

8. The metering device according to claim 1, further comprising at least one drive unit (40) which is arranged on a base frame (42) of the at least one frame unit (12), wherein the base frame (42) is fixed to the base element (16) and the plurality of pump units (14) is arranged, without a rigid connection, between two side wall elements (44, 46) of the base frame (42) at least at one end (28).

9. The metering device at least according to claim 8, wherein the at least one stiffening unit (18) comprises at least one flexurally rigid drive stiffening element (48) on which the at least one drive unit (40) is arranged, in particular fixed, wherein the at least one drive stiffening element (48) is connected to the side wall elements (44, 46) in an at least substantially rigid manner.

10. A production machine with at least one metering device according to claim 1.
